(19) United States
(12) Patent Application Publication
(10) Pub. No.: US 2025/0050313 A1
(43) Pub. Date: Feb. 13, 2025

(54) SIMULATED MOVING BED CHROMATOGRAPHY FOR LITHIUM RECOVERY FROM BRINES USING ALUMINUM-BASED ADSORBENTS

(71) Applicant: Amalgamated Research LLC, Twin Falls, ID (US)

(72) Inventors: Peter Ferrero, Twin Falls, ID (US); Alex Risner, Twin Falls, ID (US); Olivia Gluth, Twin Falls, ID (US)

(21) Appl. No.: 18/794,892

(22) Filed: Aug. 5, 2024

Related U.S. Application Data
(60) Provisional application No. 63/531,149, filed on Aug. 7, 2023.

(51) Int. Cl. B01J 20/284; C22B 26/12

(52) U.S. Cl. CPC B01J 20/284; C22B 26/12; B01J 2220/56; B01J 2220/603

(57) ABSTRACT

A continuous chromatography system includes a plurality of treatment columns, each column of the plurality of columns including an adsorbent. The system further includes a valve system configured to operate the plurality of columns as a simulated moving bed system. The valve system includes a first valve configuration having an injection of a brine into a first column of the plurality of columns and an extraction of an eluate from a second column of the plurality of columns. The second column being a different column than the first column. The valve system further includes a second valve configuration comprising a recirculation of fluid through the plurality of columns.

### CROSS-REFERENCE TO RELATED APPLICATION

This application claims priority to U.S. Provisional Patent Application No. 63/531,149 filed Aug. 7, 2023, and entitled “SIMULATED MOVING BED CHROMATOGRAPHY FOR LITHIUM RECOVERY FROM BRINES USING ALUMINUM-BASED ADSORBENTS,” the disclosure of which is hereby incorporated by reference in its entirety.

### FIELD OF THE DISCLOSURE

This disclosure relates to systems and method of recovering lithium. In particular, the disclosure relates to systems and methods for recovering lithium from brines using aluminum-based adsorbents via simulated moving bed chromatography.

### BACKGROUND

Lithium is widely used in many industries ranging from pharmaceuticals to batteries. Recently, an increase in demand for lithium has been driven by the production of hybrid and electric vehicles. Due to its highly reactive nature, lithium is not found in its elemental form. Instead, it is usually extracted from lithium minerals such as spodumene and from lithium salts found in brine sourced from salars, salt flats, or pumped from underground sources such as geothermal and petrochemical deposits. Known methods of extracting lithium are both cost and resource intensive.

One known method to extract lithium is to allow lithium brines to concentrate by solar evaporation, followed by a precipitation reaction using sodium carbonate to form lithium carbonate. It can take years for the deposits to concentrate enough for precipitation to be feasible. As a result, large areas of land are needed for solar evaporation to produce industrial quantities of lithium carbonate.

Other drawbacks, inefficiencies, and disadvantages also exist with current systems and methods.

### SUMMARY

The embodiments disclosed herein include a continuous chromatography system, including a plurality of treatment columns, each column of the plurality of columns including an adsorbent. The continuous chromatography system includes a valve system configured to operate the plurality of columns as a simulated moving bed system. The valve system can include a first valve configuration that includes an injection of a brine into a first column of the plurality of columns and an extraction of an eluate from a second column of the plurality of columns. The second column can be a different column than the first column. The valve system further includes a second valve configuration that includes a recirculation of fluid through the plurality of columns. The first valve configuration and the second valve configuration make up a separation cycle configured to separate a lithium-rich product from impurity salts in the brine.

In some examples, the plurality of treatment columns can be between 3 columns and 10 columns. In some examples, the first valve configuration further includes an injection of an eluent into the second column of the plurality of columns and an extraction of a spent brine from a third column of the plurality of columns. In some examples, the third column is configured between the first column and the second column. In an example, the eluent can include a deionized water or a dilute salt solution including less than about 2000 ppm lithium. In an example, the brine can include a concentration of lithium. In an example, the adsorbent can include an aluminum hydroxide.

In at least one example, each column of the plurality of treatment columns can include at least one inlet valve and at least one outlet valve. In an example, when the separation cycle is complete, the valve system can be configured in a third valve configuration to inject brine into a subsequent column to the first column and extract eluate from a subsequent column to the second column. In an example, the valve system cyclically changes valve positions to modify the position of the inlet valve and the outlet valve to shift the injection of the brine and extraction of the eluate into subsequent columns of the plurality of columns each separation cycle.

In an example, a simulated moving bed separation system can include a plurality of chromatography columns fluidly connected in series. The plurality of chromatography columns can be configured to perform a separation cycle of a brine mixture. In some examples, the separation cycle can include a first step of injecting the brine mixture into a first column and simultaneously withdrawing a lithium-rich product from a second column. The separation cycle can further include a second step of recirculating fluid throughout the plurality of chromatography columns fluidly connected in series. In an example, the first step can include a first period and the second step can include a second period, where the first period is different than the second period.

In some examples, the first step further includes injecting an eluent into the second column and extracting a raffinate of spent brine from a third column. In an example, the simulated moving bed separation system further includes a fractal distributor configured to inject the brine mixture into the first column. In some examples, the system can further include a valve system providing a flow path through the plurality of chromatography columns, the valve system operable to perform the separation cycle. In an example, the valve system is configured to maintain a continuous separation process.

In some examples, a method of producing a lithium-rich product can include a system operating in a simulated moving bed chromatography mode by performing a separation cycle to recover lithium from a brine. The separation cycle can include loading a plurality of treatment columns with an adsorbent and conducting a first step of injecting a feed comprising a lithium-rich brine and injecting an eluent into a resin bed while simultaneously withdrawing an eluate and a raffinate, the raffinate comprising a spent brine. In an example, the method further includes conducting a second step of recirculating fluid through the plurality of treatment columns.

In an example, each column of the plurality of columns can include an inlet valve and an outlet valve. In some examples, at the conclusion of the second step in the multi-step separation treatment, a synchronous switching of the inlet and outlet valves to the subsequent column occurs that shifts the respective treatment step of each column to a subsequent treatment column. In an example, the first step can include a first period and the second step comprises a second period, where the first period is different than the second period. In an example, the duration of the first period is selected to maintain maximum resolution between the lithium and impurities in the brine. In some examples, the method of producing a lithium can further include controlling a ratio of eluate and raffinate. In some examples, the method of producing a lithium can further include controlling a ratio of feed and eluent.

### BRIEF DESCRIPTION OF THE DRAWINGS

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

FIG. 1 is a flow diagram of a first step of the method.

FIG. 2 is a spatial concentration profile of the flow diagram shown in FIG. 1.

FIG. 3 is a flow diagram of a second step of the method.

FIG. 4 is a spatial concentration profile of the flow diagram shown in FIG. 3.

FIG. 5 is a flow diagram of an iterative first step of the method.

FIG. 6 is a spatial concentration profile of the flow diagram shown in FIG. 5.

FIG. 7 is a flow diagram of an iterative second step of the method.

FIG. 8 is a spatial concentration profile of the flow diagram shown in FIG. 7.

FIG. 9 is an embodiment of a fractal distributor for use in lithium extraction.

FIG. 10 shows an embodiment of a known (prior art) ion-exchange batch system.

FIG. 11 shows an example of a concentration profile of lithium and magnesium for an adsorbent saturation step.

FIG. 12 shows an example of a concentration profile of lithium and magnesium during an elution step.

### DETAILED DESCRIPTION

The embodiments disclosed herein include producing a fraction of lithium using a two-step cycle via a simulated moving bed (“SMB”) of injecting brine and deionized water into a resin bed without intermediate rinse steps using spent brine and lithium solutions and then recirculating the fluid within the SMB to increase the separation of lithium product from impurity salts.

In some examples, a known method to extract lithium can include a process called direct lithium extraction (“DLE”). This process is accomplished by adsorption of aqueous lithium on a suitable solid-phase adsorbent. Adsorbents for DLE have been developed utilizing three primary inorganic matrices for support: aluminum hydroxide, titanium dioxide, and manganese oxide. Titanium dioxide and manganese oxide adsorbents rely on splitting the lithium salt into the respective cation and anion, followed by exchanging protons bound on the surface of the adsorbent with the monovalent lithium. The lithium is then stripped using an acid such as hydrochloric or sulfuric acid, forming lithium chloride or lithium sulfate, respectively. These adsorbents use a four-step process to accomplish this separation: extraction of lithium from the feed material, a rinse with demineralized water to force the residual feed material out of the system, elution with acid to collect the lithium product and regenerate the adsorbent binding sites, and a second rinse with deionized water to remove any residual acid in the system prior to starting the next extraction step.

Aluminum hydroxide adsorbents are favorable for DLE processes due to the lack of chemical consumption, which can lower operating costs and simplify logistics. However, DLE plants are known to be capital intensive and are typically located in remote areas with limited access to water. Known DLE processes using an aluminum hydroxide adsorbent are operated batch-wise, with batch operation operated using a lead-lag configuration, or using a continuous counter-current ion exchange (“CCIX”) system utilizing a rotary or multi-port valve configuration. The operation of ion-exchange and adsorption systems may be viewed in terms of the location of the mass transfer zone (“MTZ”) where lithium actively binds to the solid adsorbent in the resin until elution with water. Located on the sides of the MTZ is freshly regenerated adsorbent that is able to bind more lithium and saturated adsorbent that has already bound the maximum amount of lithium.

For example, FIG. 10 shows an embodiment of a known ion-exchange batch system 1000. A batch system includes a containment vessel 1010 having an inlet 1020, an outlet 1030, and a plurality of resin layers. The plurality of resin layers includes a layer of fresh resin 1040, a layer of working resin 1050, and a layer of saturated resin 1060. The layer of fresh resin 1040 includes ions of the same charge as ions within a feed material and are bound to co-ions in the resin of an opposite charge. In operation, a feed material is provided into the inlet 1020 of the containment vessel. As the feed material passes through the plurality of resin layers, the ions of the feed material bind to the fresh resin 1040 and the ions of the resin are transferred into the feed material. The spent solution is then drained through the outlet. The ions bound within the layer of saturated resin 1060 are later stripped from the resin.

In a CCIX system, both the resin and the liquid phases are moved continuously. This is beneficial as less resin is needed to treat greater volumes of feed material. In terms of operation, CCIX systems seek to maximize the spread of the MTZ across the largest possible number of columns to increase contact of lithium with the adsorbent. As a result, leakage of the lithium can occur when the resin becomes saturated, and a portion of the lithium passes through the resin and continues into the solution. Aluminum hydroxide adsorbents have been viewed by those skilled in the art to need a four-step process where 1) the adsorbent is saturated with brine solution, 2) excess brine is rinsed from the adsorbent, 3) demineralized water elutes the bound lithium from the adsorbent, 4) the adsorbent is conditioned with spent, lithium-depleted brine to prepare for binding more lithium. The produced product is a lithium salt with the same counter-anion found in the feed brine.

One drawback of CCIX systems is the restrictions on the maximum pipe diameter that rotary or multi-port valves can accommodate. This limitation places a restriction on the maximum size column that can be incorporated into a rotary valve or multi-port valve system and leads to a large number of CCIX systems operating simultaneously to produce lithium carbonate. For example, many CCIX system have a production capacity of 1,000 and 2,000 tons of lithium carbonate per year with the use of thirty columns. In order to scale production, capital expenses often increase linearly with production output as a consequence of using known methods utilizing rotary and multi-port valves.

Furthermore, rotary and multi-port valve systems constantly inject new brine and withdraw a raffinate, such that bands of product span across multiple columns of the CCIX system. In some instances, CCIX systems attempt to consolidate the total adsorbent volume into fewer, larger vessels to benefit from economies of scale. However, a challenge that limits the effectiveness of utilizing larger columns is the division and distribution of brine across the large cross-sectional areas of larger diameter columns as some distributor systems may only distribute fluid effectively to columns of up to four meters in diameter. For example, radial and lateral distributors consist of piping layouts that are non-symmetrical and contain significant hold-up volume within the internal piping, particularly when scaling to columns exceeding four meters in diameter. Since the layout of piping to each outlet in these distributors is not symmetrical, the residence time of fluid traveling from the central inlet pipe to each distributor outlet hole is not identical and may cause an uneven distribution of residence times within the fluid distributor, which is further exacerbated as the cross-sectional area of the column increases. This uneven distribution broadens the MTZ as the brine passes through the fluid distributor to the packed resin bed such that the lithium may continue to be intermingled with salt impurities. In order to mitigate these effects, less brine is loaded per column to inhibit lithium leakage and/or more eluent is used to elute residual lithium bound to the adsorbent.

SMB chromatography is a continuous chromatographic separation process containing three or more columns packed with adsorbent that are linked together in a loop configuration. The columns are loaded with a feed brine which can be flowed through the column to ensure saturation prior to the first elution and continuous operation. The flowrates of each column in the loop are controlled in a precise manner that maintains the recovery and purity of a desirable product by confining the mass transfer zones (MTZ) of the target product and impurities in user defined locations. The operation of the SMB proceeds in steps where at the conclusion of the second step, a synchronous switching of the inlet and outlet valves to the next column downstream in the SMB loop occurs. The SMB process only partially withdraws product from the column recirculation loop, which allows product to accumulate within the system at higher concentrations and reduces the need for eluent compared to batch and CCIX processes. Furthermore, in contrast to CCIX processes, which seeks to maximize the length of the MTZ over many columns, the operation of the SMB seeks to minimize the length of the MTZ to increase the effective use of the adsorbent while also achieving high purity and recovery of valuable materials with minimized eluent usage.

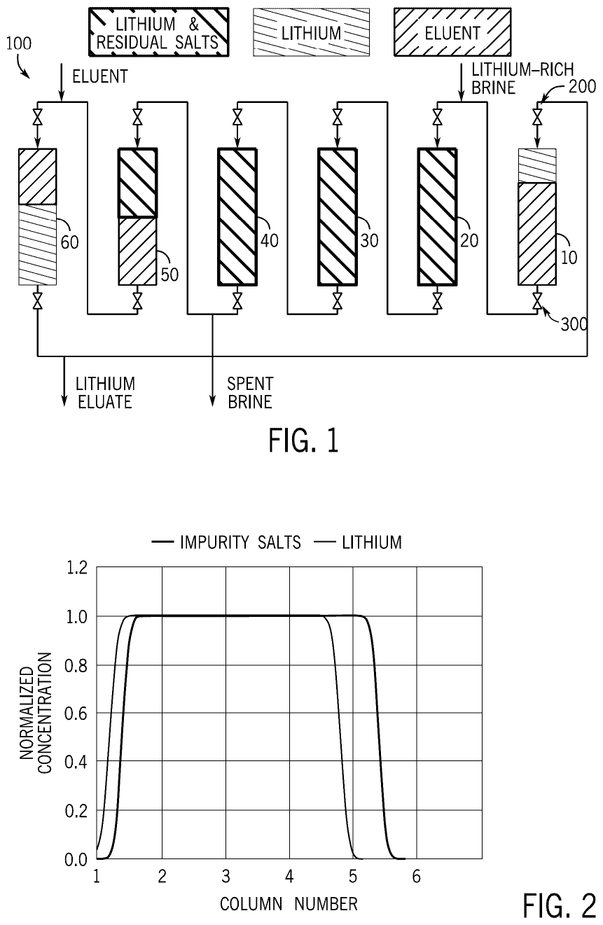

FIGS. 1-8 illustrate a method of producing a fraction of lithium using a two-step cycle of injecting brine and an eluent, where the eluent is a fluid such as deionized water or a dilute salt solution containing lithium in the range of 0-2000 ppm, into a resin bed via a SMB 100 without intermediate rinse steps using spent brine and lithium solutions. The SMB system 100 includes a plurality of treatment columns, each column of the plurality of columns including an adsorbent and a valve system configured to operate the plurality of columns as a simulated moving bed system. Each column of the plurality of columns includes at least one inlet valve manifold of the inlet valve system 200 and at least one outlet valve manifold of the outlet valve system 300. In some examples, the valve system 300 can include two or more inlet valves and/or two or more outlet valves for each column of the plurality of columns. For instance, the valve system 300 can include at least one valve for each input (e.g., injected brine, and eluent) and each output (e.g., spent brine, and eluate) at each column of the SMB system 100. Thus, the depiction of the valves in the figures is intended to be exemplary and not limiting in any way. The valve system is configured to maintain a continuous separation process.

Each iteration of the cycle is divided into two steps having distinct periods. Collectively, the two periods equal the time to move one bed volume. During the first step, a lithium brine is injected into an SMB feed column for a first period. FIG. 1 shows the feed column as column 20. The duration of the injection is selected to minimize the width of the band of lithium brine to maintain maximum resolution between the lithium and other salt impurities. Furthermore, narrowing the width of the band of lithium brine injected into the column 20 can reduce the likelihood of lithium leakage. A portion of the brine that has passed through the packed beds (i.e., spent brine) is also withdrawn from the system from a second column, column 40 in FIG. 1, so that salt impurities may be removed from the system through the raffinate stream. The first step or period includes a first valve configuration that is configured to transfer fluid into and out of the SMB system 100.

A second purpose for this first period is to withdraw the lithium-rich product from the internal profile accumulated within the SMB 100 while minimizing losses of lithium to the SMB raffinate due to the narrow profile collected from the SMB system 100. An eluent, such as deionized water or a dilute brine solution containing lithium in the range of 0-2000 ppm, is fed into the system to remove the lithium-rich product as a lithium eluate. The eluent is supplied into a different column than the lithium-rich brine. For example, in FIG. 1, the eluent is supplied into column 60.

During the first period, a ratio of eluent-to-feed affects the amount of raffinate impurities allowed to traverse the eluent column (e.g., column 60) and cross-contaminate the lithium-rich extract stream. In particular, the ratio of the volumetric flowrate of eluent fed into the system with respect to the volumetric flowrate of feed brine is selected to reduce cross-contamination of the lithium-rich extract with the raffinate stream.

Also, during the first period, an extract-to-raffinate ratio can also be controlled to increase the purity of the lithium. The extract-to-raffinate ratio is the amount of lithium eluate withdrawn relative to the raffinate flowrate. Higher ratios of extract-to-raffinate increase the likelihood of cross-contamination. In contrast, lower ratios of extract-to-raffinate increase the lithium salts that accumulate in the extract stream and increase the concentration of lithium.

In the second step, the fluid within the SMB 100 is recirculated around the SMB loop for a second period to increase the separation between the lithium and salt impurities. Throughout the second period, no new material is injected or withdrawn from the SMB 100. In other words, no injection of brine occurs, no injection of eluent occurs, and no withdrawal of lithium or raffinate occurs. The second period includes a second valve configuration that causes a recirculation of the fluid. As fluid recirculates around the SMB loop, the separation prepares the lithium product and spent brine to be withdrawn during the next step. Together, the two periods narrow the MTZ and increase the separation between the lithium and salt impurities such that less columns are needed to produce a high purity lithium stream.

During operation in the second period, the void, also known as the SMB loop recirculation flowrate, affects both the purity and recovery of the lithium by shifting the accumulated dissolved solids in the recirculation loop between the lithium extract and raffinate streams. The first valve configuration and the second valve configuration include a separation cycle configured to separate a product from impurity salts in the brine.

Once the second step has been completed, the SMB system 100 is cycled back to the first step to withdraw the lithium extract that was prepared during the second period. However, the valve configuration is in a third valve configuration aligned to inject brine into a subsequent column to the first column and extract eluate from a subsequent column to the second column. In other words, the valve system is configured to inject brine into a neighboring (i.e., downstream) column to the first column and extract eluate from a neighboring (i.e., downstream) column to the second column. The third valve configuration performs the same actions as the first valve configuration, only the injection of the brine and extraction of the eluate occur at a subsequent column, respectively.

FIG. 1 illustrates the first period described above in connection with a six-column system. During the first period, a lithium-rich brine is supplied between column 10 and column 20. The brine extends through column 20, column 30, column 40, and a portion of column 50, where it interacts the adsorbent or resin adsorbers and produces a raffinate of spent brine. The spent brine is extracted near the end of the band of brine, such as between column 40 and column 50. While the lithium-rich brine is supplied between column 10 and column 20, an eluent, such as deionized water or a dilute salt solution containing lithium in the range 0-2000 ppm, is injected into the system at between column 50 and column 60. A band of separated lithium can be seen extending between column 60 and column 10 and is separated from the spent brine by a volume of eluent, such as water. The eluent is used to elute residual lithium bound to the adsorbent, which is extracted as a lithium eluate between column 60 and column 10.

As can be seen in FIG. 2, which shows a concentration of lithium and salts within the columns of the system at the conclusion of the first period, the concentration of lithium and impurity salts is largely overlapping following the injection of the lithium-rich brine. As a result, further extraction of lithium at this stage would be diluted with impurity salts.

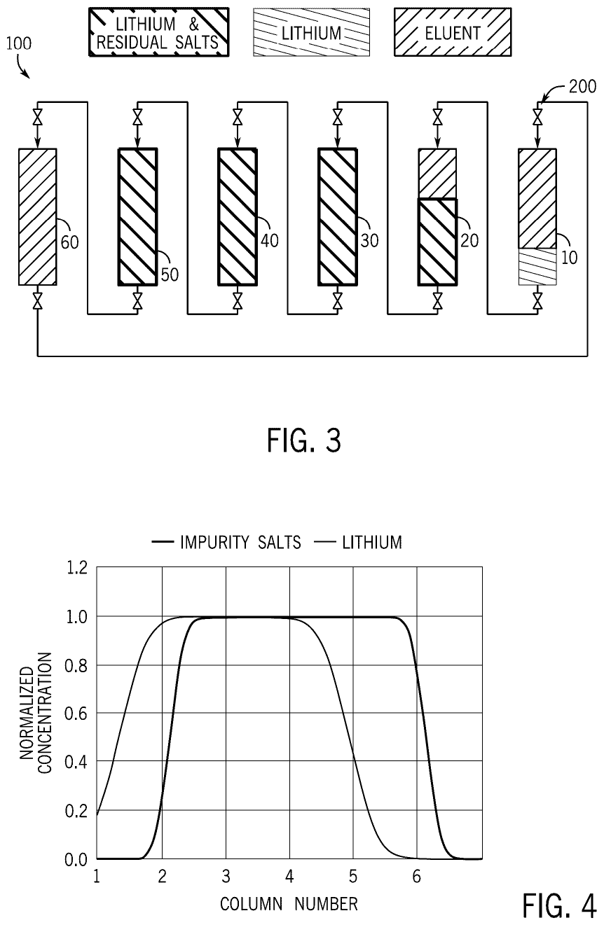

The SMB control system is then actuated to stop further injection into the SMB system 100 and extraction of materials from the SMB system 100. The fluid within the SMB 100 is recirculated around the SMB loop for a second period to increase the separation between the lithium and salt impurities. FIG. 3 illustrates the second period described above in connection with a six-column system. As can be seen in FIG. 4, the separation that occurs during the second period causes a band of concentrated lithium to form in column 10 whereas the salt impurities are concentrated in other columns. Lithium is also located within columns 20-40, but is not yet ready for extraction as it is still separating from the impurity salts. The two-step method is then iterated to remove at least some of the concentrated lithium and the spent brine from the system.

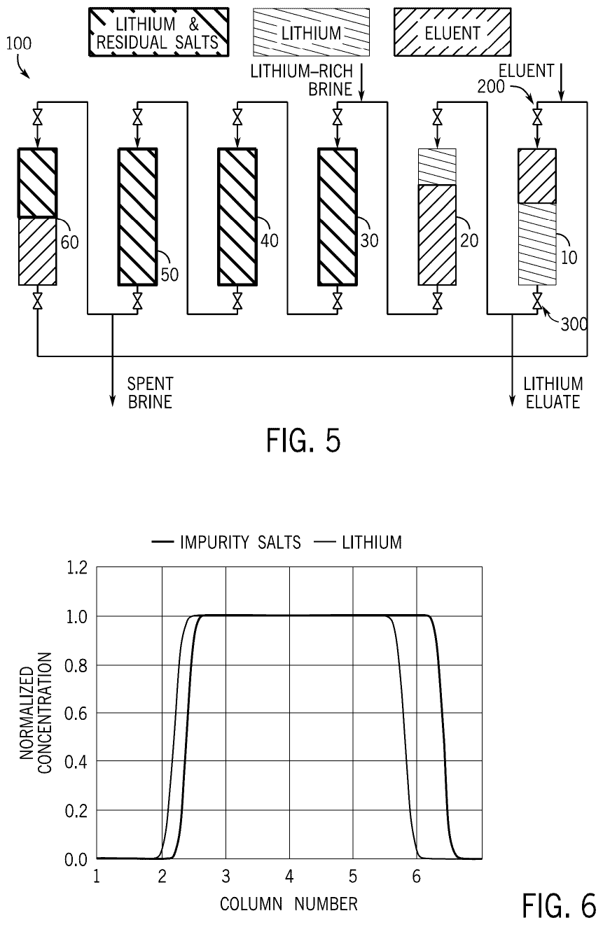

At the conclusion of the second period, the SMB 100 synchronously switches the inlet 200 and outlet 300 valves to the next column downstream in the SMB loop. For example, as shown in FIG. 5, in contrast to the lithium-rich brine being injected into the feed column 20, the feed column is now column 30. Thus, an outlet valve 300 is now positioned to extract the concentrated lithium eluate from column 10. Another outlet valve 300 is now positioned between column 50 and column 60 to extract the spent brine, which has a low concentration of lithium and a high concentration of impurity salts. In some examples, the extraction of the spent brine is between the injection of the lithium-rich brine and the extraction of the concentrated lithium eluate. In some example systems, the injection and extraction columns can be neighboring, in other examples, the injection and extraction columns can have intermediary columns in between. Likewise, the inlet valve 200 for the lithium-rich brine is moved to the next column in preparation for further binding of lithium.

The eluent is injected into the column containing the concentrated band of lithium (i.e., column 10) in order to extract the lithium as a lithium eluate. This also prepares the resin within the SMB 100 to bind additional lithium. Simultaneously, additional lithium-rich brine is injected into the columns containing the mixture of lithium & salt impurities (i.e., column 30) while a portion of the spent brine is extracted near the end of the band of brine (i.e., column 50). As can be seen in FIG. 6, the concentration of lithium and impurity salts is largely overlapping following the injection of the lithium-rich brine.

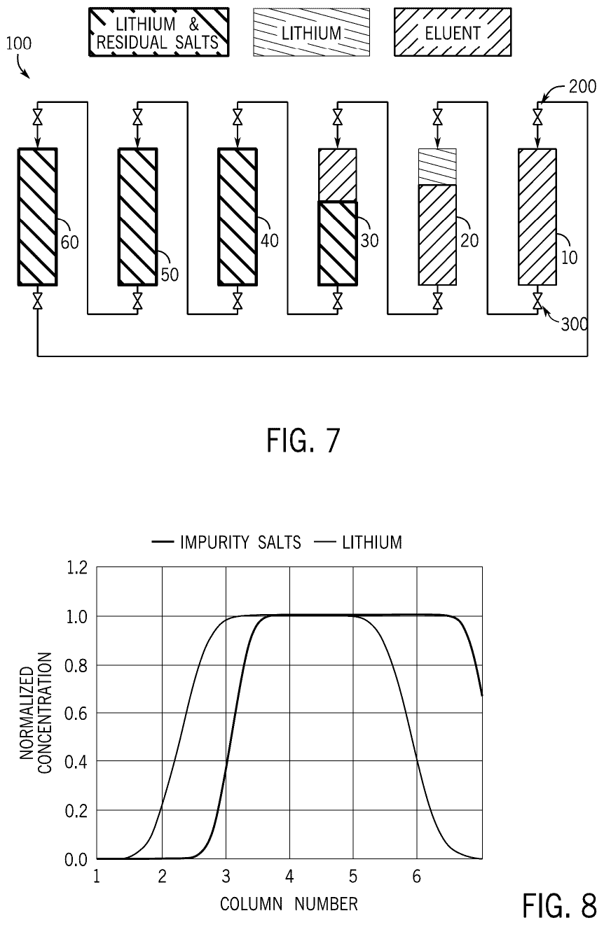

The SMB control system is again actuated to stop injection and extraction of materials into or from the SMB system 100 and the valve system is configured for recirculation. As the fluid within the SMB 100 is recirculated around the SMB loop for a second period, the separation that occurs again causes a concentrated band of lithium to form, as shown in FIGS. 7 and 8, in preparation for extraction.

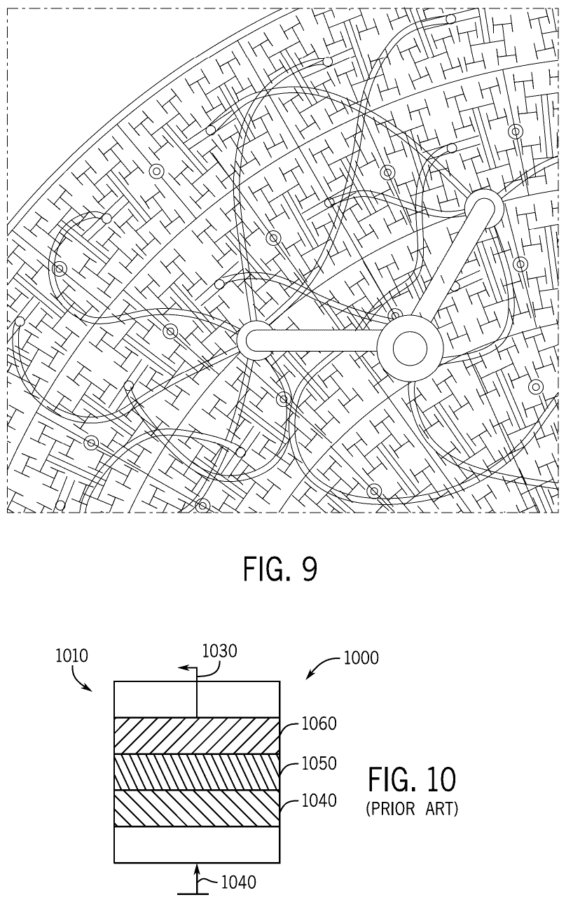

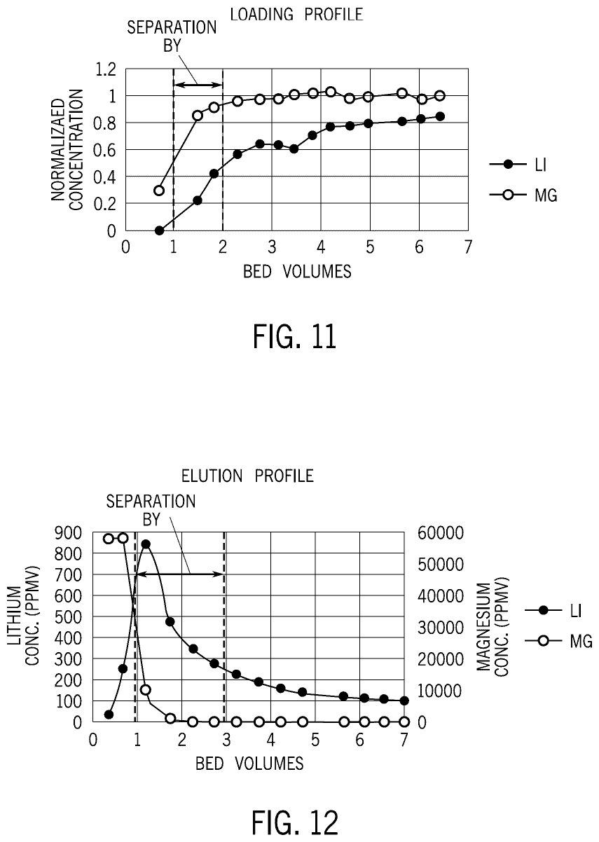

The method may include using a fractal distributor to inject brine into the system. The benefits of the SMB process described above may be compounded when used with a fractal distributor. A fractal distributor includes a flow path having a self-similar pattern that iterates from large to small scale. By way of example, a fractal distributor may be a distributor as shown in U.S. Pat. No. 5,354,460 titled Fluid transfer system with uniform fluid distributor, which is incorporated by reference in its entirety. In some embodiments, a fractal distributor may be used with columns exceeding four-meters in diameter, such as columns exceeding six-meters in diameter. An embodiment of a fractal distributor is shown in FIG. 9.

The use of fractal distribution with a lithium-rich brine is beneficial as it allows the system to achieve plug flow, or close thereto, throughout the packed-bed adsorber even with large systems having columns with diameters greater than six-meters. During operation, the residence time from the central inlet to each outlet along the fractal distributor is identical. As a result, the size and shape of the MTZ is maintained across the adsorbent bed and increases the amount of brine that may be loaded onto the adsorbent. Furthermore, the self-repeating nature of the fractal distributor pattern allows for scale-up to exceptionally large column diameters while maintaining lithium purity and recovery.

### EXAMPLES

The following examples serve to explain the embodiments of the disclosure in more detail. These examples are not to be construed as being exhaustive or exclusive as to the scope of this disclosure.

A brine source rich in lithium was identified and obtained for testing. The concentrations of cations were measured using inductively-coupled plasma optical emission spectroscopy (ICP-OES) and are reported in Table 1.

TABLE 1

| Cation | Lithium | Sodium | Magnesium | Potassium | Calcium |
|---|---|---|---|---|---|
| Concentration | 495 | 10,293 | 61,163 | 12,257 | 216 |
| (ppmv) | | | | | |

Prior to testing, the adsorbent was backwashed in a brine containing 100 mg/L lithium and 10 wt % NaCl. The adsorbent was loaded into a 7-cell Simulated Moving Bed Chromatography system where each vertical cell had a volume of 3,089 mL. During the first step of the chromatography sequence, the feed brine was injected into the top of the first column at a rate of 286 mL/min. De-ionized water as the eluent was injected into the top of the fifth column at an Eluent/Feed ratio of 1.04. Spent brine (raffinate) was withdrawn from the bottom of the third column at a rate of 348 mL/min and lithium-rich product (extract) was withdrawn from the bottom of the fifth column at an Extract/Raffinate ratio of 0.68. The base recirculation rate in the system was 62 mL/min. During the second step of the chromatography sequence, the inlet and outlet valves were closed and the fluid was circulated through the columns at a rate of 62 mL/min. The duration of the first and second steps were 40 minutes and 20 minutes, respectively.

At the conclusion of the second step, the inlet and outlet valves were opened such that the feed and eluent were injected and the raffinate and extract were withdraw one column downstream of the previous injection and withdrawal locations. The system was operated continuously for 42 hours before collection of a composite sample over the course of seven hours. Samples were then collected every 24 hours over the course of seven hours until the inventory of feed brine was depleted. The results obtained from five of the samples were averaged and are displayed in Table 2 below.

TABLE 2
SMB DLE System for 250 ppm brine

| | | | | | | | | | Productivity |
|---|---|---|---|---|---|---|---|---|---|
| | Cation Concentration | | | | | Lithium | | Lithium | [kg LCE/ |
| | [mg/L] | | | | | TDS | Lithium | Concentration | m³ |
| Stream | Li | Na | K | Mg | Ca | Purity | Recovery | Factor | resin/day] |
| Feed | 246 | 47544 | 3979 | 564 | 1318 | 16.1% | 93.6% | 1.13 | 16.1 |
| Extract | 279 | 10 | 1 | 1 | 1 | | | | |
| Raffinate | 6 | 39633 | 3297 | 470 | 1120 | | | | |

Although various embodiments have been shown and described, the present disclosure is not so limited and will be understood to include all such modifications and variations would be apparent to one skilled in the art.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

What is claimed is:

1. A continuous chromatography system, comprising:
a plurality of treatment columns, each column of the plurality of columns including an adsorbent;
a valve system configured to operate the plurality of columns as a simulated moving bed system, wherein the valve system comprises:
a first valve configuration comprising an injection of a brine into a first column of the plurality of columns and an extraction of an eluate from a second column of the plurality of columns, wherein the second column comprises a different column than the first column;
a second valve configuration comprising a recirculation of fluid through the plurality of columns;
wherein the first valve configuration and the second valve configuration comprise a separation cycle configured to separate a product from impurity salts in the brine.

2. The continuous chromatography system of claim 1, wherein the plurality of columns comprises between 3 columns and 10 columns.

3. The continuous chromatography system of claim 1, wherein the first valve configuration further comprises an injection of an eluent into the second column of the plurality of columns and an extraction of a spent brine from a third column of the plurality of columns.

4. The continuous chromatography system of claim 3, wherein the eluent comprises a deionized water or a dilute salt solution including less than about 2000 ppm lithium.

5. The continuous chromatography system of claim 1, wherein the brine comprises a concentration of lithium.

6. The continuous chromatography system of claim 1, wherein the adsorbent comprises an aluminum hydroxide.

7. The continuous chromatography system of claim 1, wherein each column of the plurality of treatment columns comprises at least one inlet valve and at least one outlet valve.

8. The continuous chromatography system of claim 7, wherein when the separation cycle is complete, the valve system is configured in a third valve configuration to inject brine into a subsequent column to the first column and extract eluate from a subsequent column to the second column.

9. The continuous chromatography system of claim 7, wherein the valve system cyclically changes valve positions to modify the position of the inlet valve and the outlet valve to shift the injection of the brine and extraction of the eluate into subsequent columns of the plurality of columns each separation cycle.

10. A simulated moving bed separation system, comprising:
a plurality of chromatography columns fluidly connected in series, the plurality of chromatography columns configured to perform a separation cycle of a brine mixture;
wherein the separation cycle comprises:
a first step of injecting the brine mixture into a first column and simultaneously withdrawing a lithium-rich product from a second column; and
a second step of recirculating fluid throughout the plurality of chromatography columns fluidly connected in series;
wherein the first step comprises a first period and the second step comprises a second period, wherein the first period is different than the second period.

11. The system of claim 10, wherein the first step further comprises injecting an eluent into the second column and extracting a raffinate of spent brine from a third column, wherein the third column is configured between the first column and the second column.

12. The system of claim 10, further comprising a fractal distributor configured to inject the brine mixture into the first column.

13. The system of claim 10, further comprising a valve system providing a flow path through the plurality of chromatography columns, the valve system operable to perform the separation cycle.

14. The system of claim 13, wherein the valve system is configured to maintain a continuous separation process.

15. A method of producing a lithium-rich product comprising:
forming a system operating in a simulated moving bed chromatography mode by performing a separation cycle to recover lithium from a brine, the separation cycle comprising:
loading a plurality of treatment columns with an adsorbent;
conducting a first step of injecting a feed comprising a lithium-rich brine and injecting an eluent into a resin bed while simultaneously withdrawing an eluate and a raffinate, the raffinate comprising a spent brine; and
conducting a second step of recirculating fluid through the plurality of treatment columns.

16. The method of claim 15, wherein each column of the plurality of columns comprises an inlet valve and an outlet valve, wherein at the conclusion of the second step in the multi-step separation treatment, a synchronous switching of the inlet and outlet valves to the subsequent column occurs that shifts the respective treatment step of each column to a subsequent treatment column.

17. The method of claim 15, wherein the first step comprises a first period and the second step comprises a second period, wherein the first period is different than the second period.

18. The method of claim 17, wherein the duration of the first period is selected to maintain maximum resolution between the lithium and impurities in the brine.

19. The method of claim 15, further comprising controlling a ratio of eluate and raffinate.

20. The method of claim 15, further comprising controlling a ratio of feed and eluent.
